(19) United States
(12) Patent Application Publication
(10) Pub. No.: US 2026/0211806 A1
(43) Pub. Date: Jul. 23, 2026

(54) SYSTEMS AND METHODS FOR OPTIMIZING MEMORY ALLOCATION FOR NEURAL PROCESSING UNIT WITH NOTEBOOK IN CLOSED POSITION

(71) Applicant: Dell Products L.P., Round Rock, TX (US)

(72) Inventors: Jace W. FILES, Round Rock, TX (US); John T. MORRISON, Round Rock, TX (US); David J. ZAVELSON, Austin, TX (US)

(73) Assignee: Dell Products L.P., Round Rock, TX (US)

(21) Appl. No.: 19/035,298

(22) Filed: Jan. 23, 2025

(51) Int. Cl. G06F 12/02

(52) U.S. Cl. CPC G06F 12/023

(57) ABSTRACT

A method may include, in response to a display assembly of an information handling system being manipulated from an open position to a closed position relative to a keyboard assembly of the information handling system, determining services of the information handling system needed in a special mode of operation of the information handling system that executes in the closed position, determining services of the information handling system needed in a normal mode of operation of the information handling system that executes in the open position which are not needed in the special mode of operation, and causing memory allocation within a memory of the information handling system of services needed in a normal mode of operation which are not needed in the special mode of operation to be transferred from the memory to virtual memory within a storage resource of the information handling system.

### TECHNICAL FIELD

The present disclosure relates in general to information handling systems, and more particularly to systems and methods for optimizing memory allocation for a neural processing unit in a notebook while the notebook is in a closed position.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a notebook computer, which may also be referred to as a laptop. A notebook may comprise a display assembly rotatably coupled to a keyboard assembly via a hinge, allowing a user to open the display assembly relative to the keyboard assembly to a desired angle, as well as close the keyboard assembly relative to the display assembly to an angle of approximately zero degrees.

Increasingly, notebooks are being designed to remain at least partially functional and undertake particular tasks when closed. For example, a notebook may playback audio, conduct an audio conference, record audio, or undertake other tasks while closed. As another example, a notebook may perform advanced artificial intelligence functions when a notebook is in a closed position using a neural processing unit. Accordingly, it may be desirable to optimize memory capacity for use by a neural processing unit when a notebook is in a closed position.

### SUMMARY

In accordance with the teachings of the present disclosure, the disadvantages and problems associated with traditional approaches to functionality of a notebook in a closed position may be substantially reduced or eliminated.

In accordance with embodiments of the present disclosure, an information handling system may include a keyboard assembly, a display assembly rotatably coupled to the keyboard assembly, a memory housed within one of the keyboard assembly and the display assembly, a storage resource housed within one of the keyboard assembly and the display assembly, and a processor housed within one of the keyboard assembly and the display assembly and communicatively coupled to the memory and the storage resource. The processor may be configured to, in response to the display assembly being manipulated from an open position to a closed position relative to the keyboard assembly, determine services of the information handling system needed in a special mode of operation of the information handling system that executes in the closed position, determine services of the information handling system needed in a normal mode of operation of the information handling system that executes in the open position which are not needed in the special mode of operation, and cause memory allocation within the memory of services needed in a normal mode of operation which are not needed in the special mode of operation to be transferred from the memory to virtual memory within the storage resource.

In accordance with these and other embodiments of the present disclosure, a method may be provided for an information handling system comprising a keyboard assembly, a display assembly rotatably coupled to the keyboard assembly, a memory housed within one of the keyboard assembly and the display assembly, and a storage resource housed within one of the keyboard assembly and the display assembly. The method may include, in response to the display assembly being manipulated from an open position to a closed position relative to the keyboard assembly, determining services of the information handling system needed in a special mode of operation of the information handling system that executes in the closed position, determining services of the information handling system needed in a normal mode of operation of the information handling system that executes in the open position which are not needed in the special mode of operation, and causing memory allocation within the memory of services needed in a normal mode of operation which are not needed in the special mode of operation to be transferred from the memory to virtual memory within the storage resource.

In accordance with these and other embodiments of the present disclosure, an article of manufacture may include a non-transitory computer-readable medium and computer-executable instructions carried on the computer-readable medium, the instructions readable by a processor, the instructions, when read and executed, for causing the processor to, in an information handling system comprising a keyboard assembly, a display assembly rotatably coupled to the keyboard assembly, a memory housed within one of the keyboard assembly and the display assembly, and a storage resource housed within one of the keyboard assembly and the display assembly, in response to the display assembly being manipulated from an open position to a closed position relative to the keyboard assembly: (a) determine services of the information handling system needed in a special mode of operation of the information handling system that executes in the closed position; (b) determine services of the information handling system needed in a normal mode of operation of the information handling system that executes in the open position which are not needed in the special mode of operation; and (c) cause memory allocation within the memory of services needed in a normal mode of operation which are not needed in the special mode of operation to be transferred from the memory to virtual memory within the storage resource.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIG. 2 illustrates an isometric perspective view of selected components of an example notebook in an open position of the notebook, in accordance with embodiments of the present disclosure;

FIG. 3 illustrates an isometric perspective view of selected components of the notebook of FIG. 2 in a closed position of the notebook, in accordance with embodiments of the present disclosure; and

FIG. 4 illustrates a flow chart of an example method for optimizing memory allocation for a neural processing unit with a notebook in a closed position, in accordance with embodiments of the present disclosure.

### DETAILED DESCRIPTION

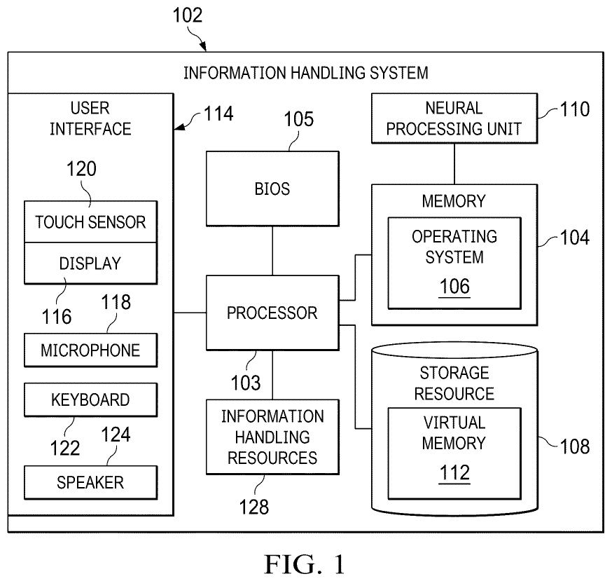

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, buses, memories, I/O devices and/or interfaces, storage resources, network interfaces, motherboards, integrated circuit packages; electro-mechanical devices (e.g., air movers), displays, and power supplies.

FIG. 1 illustrates a block diagram of selected components of an example information handling system 102, in accordance with embodiments of the present disclosure. In some embodiments, information handling system 102 may comprise or be an integral part of a server. In some embodiments, information handling system 102 may be a personal computer (e.g., a desktop computer or a portable computer). In other embodiments, information handling system 102 may comprise a mobile device (e.g., a smart phone, a tablet computing device, a handheld computing device, a personal digital assistant, or any other device that may be readily transported on a person of a user of such mobile device).

As depicted in FIG. 1, information handling system 102 may include a processor 103, a memory 104 communicatively coupled to processor 103, BIOS 105, a storage resource 108 communicatively coupled to processor 103, a neural processing unit 110 communicatively coupled to processor 103 and memory 104, a user interface 114 communicatively coupled to processor 103, and one or more information handling resources 128 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

As shown in FIG. 1, memory 104 may have stored therein an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105.

A storage resource 108 may include one or more hard disk drives, magnetic tape libraries, optical disk drives, magneto-optical disk drives, compact disk drives, compact disk arrays, disk array controllers, and/or any other system, apparatus or device operable to store media. In some embodiments, storage resource 108 may comprise a plurality of physical storage resources that may appear to operating system 106 or a virtual machine executing on information handling system 102 as a single logical storage unit or virtual storage resource. For example, each such virtual storage resource may comprise a RAID. Thus, in some embodiments, a virtual storage resource may comprise a redundant array of physical storage resources. In the same or alternative embodiments, a virtual storage resource may be implemented using a RAID standard. Although FIG. 1 depicts storage resource 108 internal to information handling system 102, in some embodiments, storage resource 108 may be external to information handling system 102 (e.g., embodied by a physical array of external hard disk drives).

As shown in FIG. 1, a portion of storage resource 108 may be allocated to virtual memory 112. Generally speaking, virtual memory is a memory management technique that provides an abstraction of the storage resources that are actually available on an information handling system which creates an illusion to users of a very large memory. In other words, operating system 106, using a combination of hardware and software, may map memory addresses used by a program, called virtual addresses, into physical addresses in memory 104. Storage resource 108, as seen by a process or task executing on processor 103 or neural processing unit 110, may appear as a contiguous address space or collection of contiguous segments. Operating system 106 may manage virtual address spaces and the assignment of real memory to virtual memory. Address translation hardware in the processor 103, often referred to as a memory management unit (MMU), may automatically translate virtual addresses to physical addresses. Software within operating system 106 may extend these capabilities, utilizing, e.g., storage resource 108, to provide a virtual address space (i.e., virtual memory 112) that may exceed the capacity of real memory and thus reference more memory 104 than is physically present in information handling system 102.

Neural processing unit 110 may be any system, device, or apparatus within a class of specialized hardware accelerators which accelerate artificial intelligence and machine learning applications, including artificial neural networks and computer vision. Typical applications include algorithms for robotics, Internet of Things, and other data-intensive or sensor-driven tasks. In some embodiments, processor 103 and neural processing unit 110 may be integrated within the same integrated circuit. Further, in these and other embodiments, processor 103 and neural processing unit 110 may share memory 104.

User interface 114 may comprise any instrumentality or aggregation of instrumentalities by which a user may interact with information handling system 102. For example, user interface 114 may permit a user to input data and/or instructions into information handling system 102 (e.g., via a keypad, keyboard, touch screen, microphone, camera, and/or other data input device), and/or otherwise manipulate information handling system 102 and its associated components. User interface 114 may also permit information handling system 102 to communicate data to a user (e.g., via a display device, speaker, and/or other data output device). As shown in FIG. 1, user interface 114 may include one or more of each of a display 116, a microphone 118, a keyboard 122, a speaker 124, a touch sensor 120 associated with display 116, and/or one or more other input and/or output devices.

Display 116 may comprise any suitable system, device, or apparatus configured to display human-perceptible graphical data and/or alphanumeric data to a user. For example, in some embodiments, display 116 may comprise a liquid crystal display or organic light-emitting diode display.

Touch sensor 120 may be mechanically coupled to and may overlay display 116, and may include any suitable system, device, or apparatus configured to sense contact from (or in some instances, proximity to) a stylus or a user's finger or hand with the surface of touch sensor 120 and detect a position of such contact on the surface. Accordingly, the combination of display 116 and touch sensor 120 may comprise a touch screen, allowing a user to directly interact with graphical elements displayed to display 116. In some embodiments, touch sensor 120 may comprise a capacitive sensor.

Microphone 118 may comprise any system, device, or apparatus configured to convert sound incident at microphone 118 to an electrical signal that may be processed by processor 103. In some embodiments, microphone 118 may include a capacitive microphone (e.g., an electrostatic microphone, a condenser microphone, an electret microphone, a microelectromechanical systems (MEMS) microphone, etc.) wherein such sound is converted to an electrical signal using a diaphragm or membrane having an electrical capacitance that varies based on sonic vibrations received at the diaphragm or membrane.

Keyboard 122 may comprise any system, device, or apparatus modeled after a typewriter keyboard which uses an arrangement of buttons or keys to act as mechanical levers or electronic switches to allow a user to enter text, numbers, and/or symbols into operating system 106 or application software running on operating system 106.

Speaker 124 may comprise any system, device, or apparatus configured to produce sound in response to electrical audio signal input.

In addition to processor 103, memory 104, BIOS 105, storage resource 108, neural processing unit 110, and user interface 114, information handling system 102 may include one or more other information handling resources 128. Such an information handling resource 128 may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

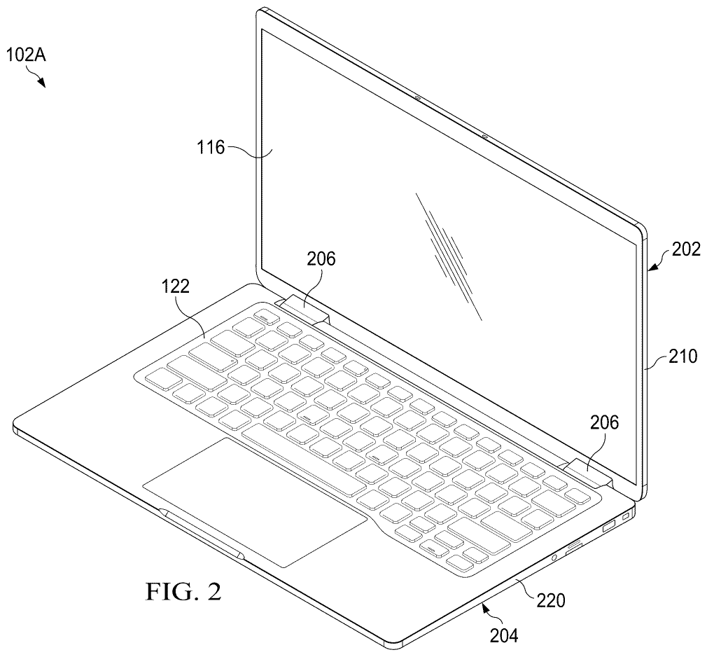

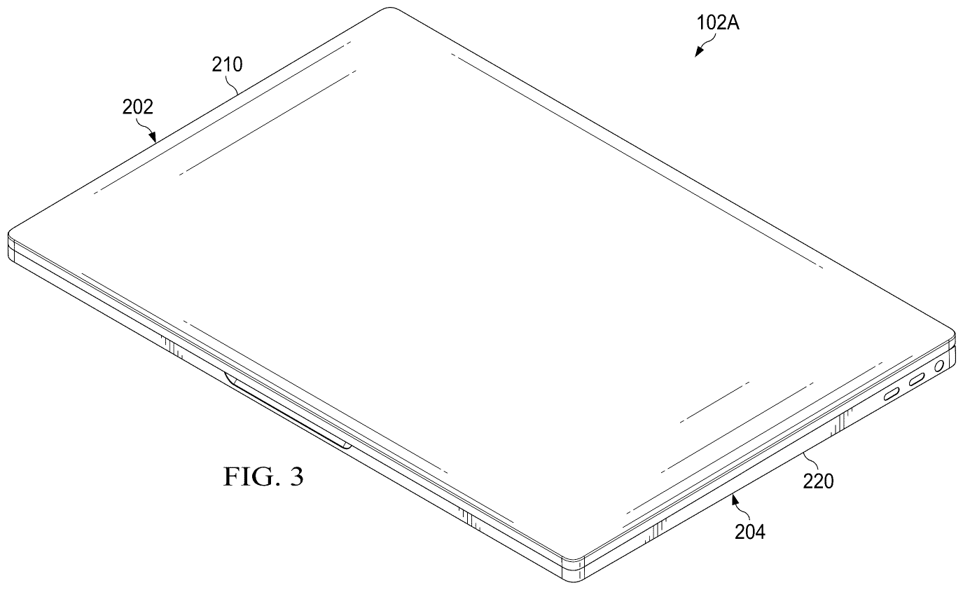

FIG. 2 illustrates an isometric perspective view of selected components of an example notebook 102A in an open position, in accordance with embodiments of the present disclosure. FIG. 3 illustrates an isometric perspective view of selected components of example notebook 102A in a closed position, in accordance with embodiments of the present disclosure. Notebook 102A may implement information handling system 102.

As shown in FIGS. 2 and 3, notebook 102A may include a display assembly 202 and a keyboard assembly 204 rotatably coupled to one another via one or more hinges 206. Display assembly 202 may comprise a housing 210 that may house components of notebook 102A including a display 116. Keyboard assembly 204 may comprise a housing 220 that may house components of notebook 102A including keyboard 122 for inputting information to notebook 102A. Keyboard assembly 204 may also include other components of information handling system 102 (e.g., processor 103, memory 104, BIOS 105, certain components of user interface 114, information handling resources 128, etc.) not explicitly depicted in FIGS. 2 and 3.

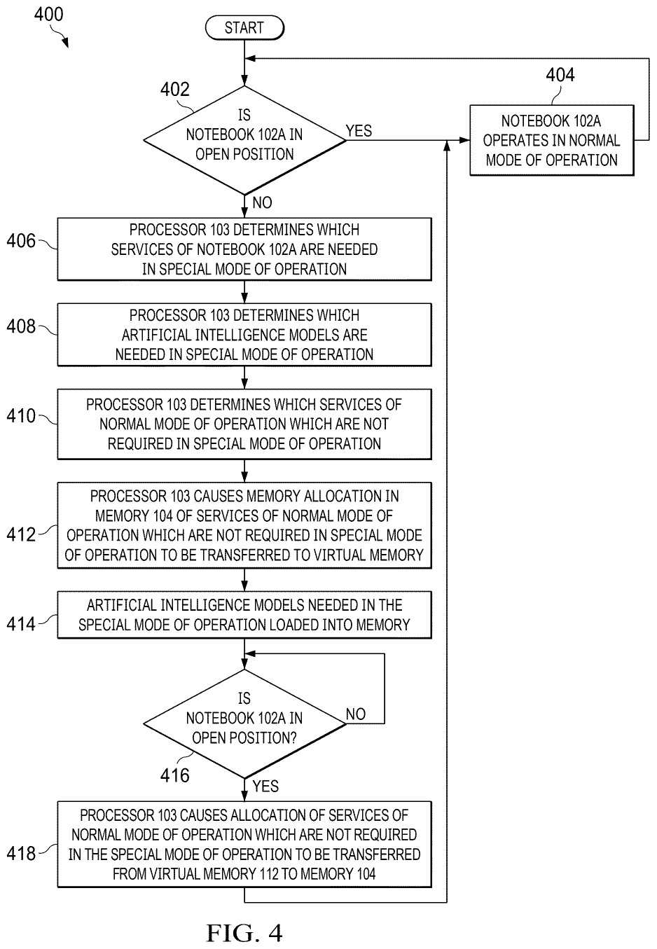

FIG. 4 illustrates a flow chart of an example method 400 for optimizing memory allocation for neural processing unit 110 with notebook 102A in its closed position, in accordance with embodiments of the present disclosure. According to some embodiments, method 400 may begin at step 402. As noted above, teachings of the present disclosure may be implemented in a variety of configurations of notebook 102A. As such, the preferred initialization point for method 400 and the order of the steps comprising method 400 may depend on the implementation chosen.

At step 402, processor 103 may determine if notebook 102A is in an open or closed position. Many methods and systems exist for determining whether a notebook is in an open or closed position, and are beyond the scope of this disclosure. If notebook 102A is in an open position, method 400 may proceed to step 404. Otherwise, method 400 may proceed to step 406.

At step 404, notebook 102A may operate in a “normal” mode of operation. After completion of step 404, method 200 may proceed again to step 402.

At step 406, notebook 102A may begin operation in a “special” mode of operation with processor 103 determining which services of notebook 102A are needed in the special mode of operation. At step 408, processor 103 may determine which artificial intelligence models are needed in the special mode of operation. At step 410, processor 103 may determine which services of the normal mode of operation are not required in the special mode of operation.

At step 412, processor 103 may cause the memory allocation in memory 104 of services of the normal mode of operation which are not required in the special mode of operation to be transferred to virtual memory 112. At step 414, artificial intelligence models needed in the special mode of operation may be loaded into memory 104. Accordingly, services not needed in the special mode of operation may be readily available to be transferred back to memory 104 should notebook 102A again enter the normal mode of operation, while providing additional capacity in memory 104 for artificial intelligence models and services needed during the special mode of operation.

At step 416, processor 103 may determine if notebook 102A is in an open or closed position. If notebook 102A is in an open position, method 400 may proceed to step 418. Otherwise, method 400 may remain at step 416 until the notebook 102A is manipulated into the open position.

At step 418, processor 103 may cause the allocation of services of the normal mode of operation which are not required in the special mode of operation to be transferred from virtual memory 112 to memory 104. After completion of step 418, method 400 may proceed to step 404.

Although FIG. 4 discloses a particular number of steps to be taken with respect to method 400, method 400 may be executed with greater or fewer steps than those depicted in FIG. 4. In addition, although FIG. 4 discloses a certain order of steps to be taken with respect to method 400, the steps comprising method 400 may be completed in any suitable order.

Method 400 may be implemented in whole or part using a variety of configurations of notebook 102A and/or any other system operable to implement method 400. In certain embodiments, method 400 may be implemented partially or fully in software and/or firmware embodied in computer-readable media.

While the terms “top,” “bottom,” “front,” “back,” and “side” are used for purposes of exposition and clarity, such terms are not intended to limit any of the components disclosed herein to a particular orientation or configuration.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a keyboard assembly;
a display assembly rotatably coupled to the keyboard assembly;
a memory housed within one of the keyboard assembly and the display assembly;
a storage resource housed within one of the keyboard assembly and the display assembly; and
a processor housed within one of the keyboard assembly and the display assembly and communicatively coupled to the memory and the storage resource and configured to, in response to the display assembly being manipulated from an open position to a closed position relative to the keyboard assembly:
determine services of the information handling system needed in a special mode of operation of the information handling system that executes in the closed position;
determine services of the information handling system needed in a normal mode of operation of the information handling system that executes in the open position which are not needed in the special mode of operation; and
cause memory allocation within the memory of services needed in a normal mode of operation which are not needed in the special mode of operation to be transferred from the memory to virtual memory within the storage resource.

2. The information handling system of claim 1, further comprising a neural processing unit housed within one of the keyboard assembly and the display assembly and communicatively coupled to the memory, wherein the processor is further configured to, in response to the display assembly being manipulated from the open position to the closed position:
determine artificial intelligence models needed for processing by the neural processing unit during the special mode of operation; and
cause the artificial intelligence models to be loaded into the memory for execution by the neural processing unit during the special mode of operation.

3. The information handling system of claim 1, the processor further configured to, in response to the display assembly being manipulated from the closed position to the open position relative to the keyboard assembly, cause allocation of services of the normal mode of operation which are not needed in the special mode of operation to be transferred from the virtual memory to the memory.

4. A method comprising, in an information handling system comprising a keyboard assembly, a display assembly rotatably coupled to the keyboard assembly, a memory housed within one of the keyboard assembly and the display assembly, and a storage resource housed within one of the keyboard assembly and the display assembly:
in response to the display assembly being manipulated from an open position to a closed position relative to the keyboard assembly:
determining services of the information handling system needed in a special mode of operation of the information handling system that executes in the closed position;
determining services of the information handling system needed in a normal mode of operation of the information handling system that executes in the open position which are not needed in the special mode of operation; and
causing memory allocation within the memory of services needed in a normal mode of operation which are not needed in the special mode of operation to be transferred from the memory to virtual memory within the storage resource.

5. The method of claim 4, wherein:
the information handling system further includes a neural processing unit housed within one of the keyboard assembly and the display assembly and communicatively coupled to the memory; and
the method further comprises, in response to the display assembly being manipulated from the open position to the closed position:
determining artificial intelligence models needed for processing by the neural processing unit during the special mode of operation; and
causing the artificial intelligence models to be loaded into the memory for execution by the neural processing unit during the special mode of operation.

6. The method of claim 4, further comprising, in response to the display assembly being manipulated from the closed position to the open position relative to the keyboard assembly, causing allocation of services of the normal mode of operation which are not needed in the special mode of operation to be transferred from the virtual memory to the memory.

7. An article of manufacture comprising:
a non-transitory computer-readable medium; and
computer-executable instructions carried on the computer-readable medium, the instructions readable by a processor, the instructions, when read and executed, for causing the processor to, in an information handling system comprising a keyboard assembly, a display assembly rotatably coupled to the keyboard assembly, a memory housed within one of the keyboard assembly and the display assembly, and a storage resource housed within one of the keyboard assembly and the display assembly:
in response to the display assembly being manipulated from an open position to a closed position relative to the keyboard assembly:
determine services of the information handling system needed in a special mode of operation of the information handling system that executes in the closed position;
determine services of the information handling system needed in a normal mode of operation of the information handling system that executes in the open position which are not needed in the special mode of operation; and
cause memory allocation within the memory of services needed in a normal mode of operation which are not needed in the special mode of operation to be transferred from the memory to virtual memory within the storage resource.

8. The article of claim 7, wherein:
the information handling system further includes a neural processing unit housed within one of the keyboard assembly and the display assembly and communicatively coupled to the memory; and
the instructions for further causing the processor to, in response to the display assembly being manipulated from the open position to the closed position:
determining artificial intelligence models needed for processing by the neural processing unit during the special mode of operation; and
causing the artificial intelligence models to be loaded into the memory for execution by the neural processing unit during the special mode of operation.

9. The article of claim 7, the instructions for further causing the processor to, in response to the display assembly being manipulated from the closed position to the open position relative to the keyboard assembly, causing allocation of services of the normal mode of operation which are not needed in the special mode of operation to be transferred from the virtual memory to the memory.
